(19) United States
(12) Patent Application Publication
(10) Pub. No.: US 2010/0203991 A1
(43) Pub. Date: Aug. 12, 2010

(54) CHAIN GUIDING ELEMENT FOR A TIMING CHAIN, TIMING CHAIN DRIVE, AND VEHICLE ENGINE

(75) Inventor: Simon Xunnan He, Troy, MI (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 12/599,781

(22) PCT Filed: Mar. 31, 2008
(86) PCT No.: PCT/EP2008/053844

§ 371 Date: Mar. 4, 2010

Related U.S. Application Data
(60) Provisional application No. 60/917,340, filed on May 11, 2007.

(51) Int. Cl. F16H 7/18; F16H 7/08

(52) U.S. Cl. 474/111; 474/140

(57) ABSTRACT

A chain guiding element (1) for a timing chain (7) of a timing chain drive, with the guiding element having a rigid base body (3) is provided. A spring element (4) is arranged on the base body (3). The side of the spring element (4) facing the control chain has a guiding surface (6) for the timing chain (7), and a space is created between the base body (3) and the side of the spring element opposite the guiding surface (6).

### BACKGROUND

The invention relates to a chain-guiding element for a timing chain, to a timing-chain drive, and also to a vehicle engine.

A chain-guiding element is used for guiding a timing chain of a timing-chain drive in a vehicle engine. From DE 199 59 594 C1, a timing-chain drive for a V-type engine with camshafts lying on the top is known. This engine has two cylinder heads arranged in a V-shape relative to each other and two camshafts for each of these cylinder heads. These camshafts are each driven by a crankshaft allocated to the two cylinder heads via a separate timing chains in a timing-chain drive. The tensioned-chain section and the non-tensioned-chain section of each of the two timing chains are each supported by a chain-guiding element. The chain-guiding elements are made from plastic. The chain-guiding element allocated to the non-tensioned-belt section is mounted so that it is adjustable. The adjustment is performed by a pressurized-oil-activated adjustment mechanism. In this way it is guaranteed that the timing chain has a constant tension during operation. Wear on the timing chain caused by long-term operation is also compensated for in this way. The chain-guiding elements on the side of each tensioned-belt section have a concave guiding surface facing the timing chain. The timing chain slides along the guiding surface under a slight lateral pressure of the guiding element. In this way, an undesired lateral movement or twisting of the timing chain is reliably prevented. The chain-guiding elements are mounted on the end face of the engine block by attachment bolts or pins.

From U.S. Pat. No. 7,056,246 B2, a chain-guiding element is known that is assembled from chain elements according to a kind of slider chain. For guiding the timing chain, the chain elements form a nearly continuous guiding surface with their adjacent sides facing the timing chain. Here, the chain-guiding element is typically mounted on the engine block, such that a concave guiding surface is produced facing the timing chain.

From US 2005/0239590 A1, a chain-guiding element is known that has a bar bent in the longitudinal direction as a base body. At the two ends of the bar there are bolt receptacles for mounting the chain-guiding element on the engine block using holding bolts. The bent bar is provided with a plastic coating across its entire length. Here, the plastic coating is constructed such that it forms a guiding surface on its side facing the timing chain.

Finally, from U.S. Pat. No. 7,063,635 B2, a chain-guiding element is known with a clip-shaped base body produced from a plastic. In the case of this base body, it involves a molded body made from plastic that has, in turn, a concave guiding surface. A spring element according to a kind of a leaf spring is arranged on the side of the base body facing away from the guiding surface. The mounting of the chain-guiding element on the engine block is realized by two holding clips formed on the two ends of the base body. The leaf spring guarantees that the timing chain is not only guided, but also that the chain-guiding element elastically absorbs the chain force acting on the guiding surface. Therefore, the continuously changing chain forces caused by the constantly changing load on the timing chain are largely absorbed. Thus, a high degree of smooth running of the timing chain can also be created for continuously changing loads, for example, caused by a change in velocity of the vehicle.

### SUMMARY

The object of the invention is to further simplify and improve the concept of an elastic chain-guiding element absorbing the chain forces of the timing chain with respect to configuration and production.

This objective is met according to the invention by a chain-guiding element with the feature combination according to Claim 1.

For this purpose, a spring element is arranged on the base body of the chain-guiding element, wherein this spring element has a guiding surface for the timing chain on its side facing the timing chain and a spacing from the base body on its side facing away from the guiding surface. The chain-guiding element here has an essentially elongated geometry, wherein its longitudinal side facing the timing chain is formed essentially by the spring element. Its geometry is relatively simple. The chain-guiding element is made from only two regions, the base body and the spring element, so that it is simple and economical to produce. The spring element absorbs the chain forces of the timing chain and thus reduces the vibrations of the timing-chain drive. Here, the chain-guiding element can be used advantageously both on the non-tensioned-chain section and also on the tensioned-chain section. By spacing the spring element away from the base body, an elastic space is formed in which the spring element can deform under the effect of a chain force. The elastic properties can be specified within a wide range through the selection of the material of the spring element and also through the spring-elastic coupling of the spring element on the base body. Thus, the chain-guiding element can be adapted in a simple way to the problem. The chain-guiding element is here mounted such that it exerts, with its guiding surface, a lateral pressure perpendicular to the direction of movement of the timing chain on this surface. It is mounted on the engine block in a simple way, for example, by attachment boreholes or holding clips that are arranged, in particular, on its two ends. Alternatively, the chain-guiding element could also be fixed on a molded part mounted on the engine block.

In one advantageous refinement, the base body and the spring element form an integral component. In other words, the chain-guiding element consisting of the base body and spring element has a one-piece construction. Preferably, the spacing between the base body and the spring element is formed by an opening. This opening typically extends in a transverse direction perpendicular to the longitudinal direction of the chain-guiding element. The opening extending in the transverse direction here extends essentially parallel to the entire guiding surface, so that the spring element is set apart from the base body in the shape of a strip. In this way, in particular, production as an integral component is made possible, so that the chain-guiding element can be constructed in one piece. Because the chain-guiding element has a simple geometry without undercuts, it can be produced as a plastic injection-molded part in a simpler and more economical way.

In one advantageous refinement, the guiding surface has a concave curvature viewed from the base body outward. Through the provision of this concave curvature, the guiding surface nestles from the side against the timing chain and thus makes possible a soft and low-friction sliding of the timing chain over the guiding surface. The chain force is thus transmitted uniformly from the timing chain to the chain-guiding element.

Preferably, the opening forming the spacing between the base body and the spring element also has a concave curve. Here, in particular, the side of the opening oriented toward the spring element has the concave curvature. If the concave curvature of the guiding surface and the concave curvature of the opening essentially match, then a spring element according to a kind of leaf spring is formed. Such a spring element could be designed especially easily with respect to its spring properties. The decisive parameters are here, in particular, the surface area of the spring element, its thickness, and also its material setting the spring constants. Furthermore, the side of the opening pointing toward the base body could also be provided with such a concave curvature. In this way, a uniform elastic space is formed across the length of the opening.

In one advantageous refinement, the opening is filled at least partially with a damping mass. The damping mass here also supports the spring element, so that the spring element is less easily mechanically damaged in the case of a high chain force. Here, the damping mass is constructed, for example, as a molded body filling the opening completely or partially. This molded body could also be fixed in the opening through adhesion, if necessary, so that it is secured against falling out in the case of vibrations in the engine block. In another configuration, in the case of the damping mass, it involves a typically soft plastic whose elasticity and strength can be specified, in particular, by its porosity. Furthermore, in the case of the damping mass, it could also involve a strip-shaped molded body that is pressed into the recess. If this molded body is sufficiently elastic, then it presses against the walls of the opening and is securely held during operation.

The objective is further met by a timing-chain drive for a vehicle engine with a chain-guiding element according to one of the preceding claims. Here, the individual configurations of the chain-guiding element are to be transferred with their advantages analogously to the timing-chain drive.

The objective is also met by a vehicle engine with such a timing-chain drive.

### BRIEF DESCRIPTION OF THE DRAWINGS

Below, two embodiments of the invention will be explained in greater detail with reference to a drawing. Shown therein are:

FIG. 1 a schematic side view of a first chain-guiding element, and

FIG. 2 a schematic side view of a second chain-guiding element.

### DETAILED DESCRIPTION OF THE PREFERRED EMBODIMENTS

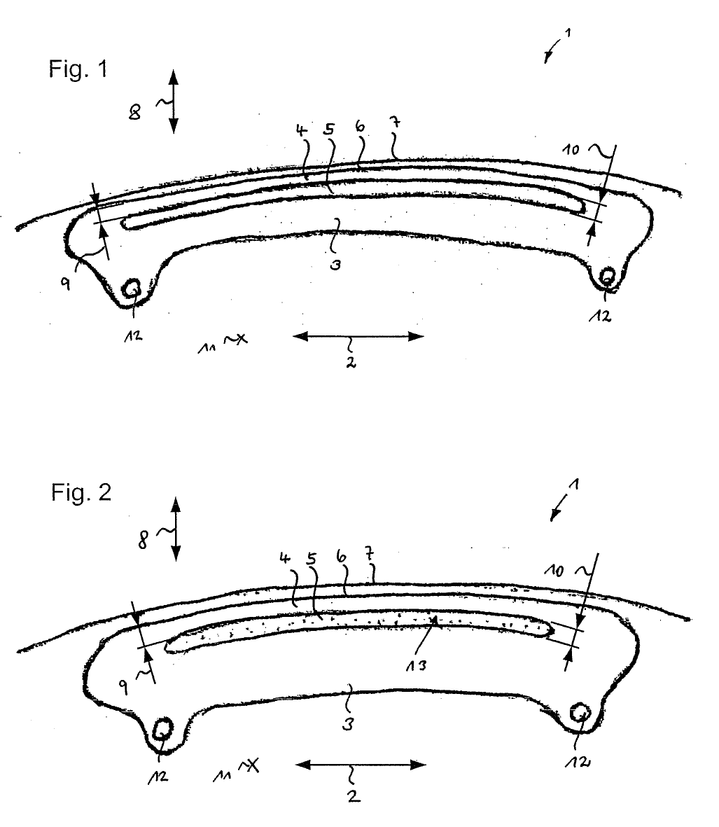

FIG. 1 shows a chain-guiding element 1 for a timing-chain drive of a vehicle engine. The timing-chain drive and the vehicle engine are not shown in the figures. The chain-guiding element 1 has a base body 3 extending essentially in the longitudinal direction 2. A spring element 4 is essentially separated from the base body 3 by an opening 5 extending essentially likewise in the longitudinal direction 2. The chain-guiding element here has a one-piece configuration. It can be produced, for example, as a plastic injection-molded part. The base body 3 and the spring element 4 are merely connected to each other at the two ends of the chain-guiding element 1. The spring element 4 is oriented with a guiding surface 6 toward a timing chain 7. In the figure, with respect to the timing chain 7, only its contours oriented toward the guiding surface 6 are shown. The guiding surface 6 has a concave curvature facing the timing chain 7. In this way, a lateral pressure is exerted in the vertical direction 8 onto the timing chain 7 moving in the longitudinal direction 2 towards the left or towards the right.

The side of the opening 5 oriented toward the spring element 4 also has a concave curvature. Here, the concave curvature of the opening 5 corresponds essentially to the concave curvature of the guiding surface 6, so that the spring element 4 is formed with a strip-like shape with an essentially constant thickness 9 in the longitudinal direction 2. The side of the opening 5 oriented toward the base body 3 in the longitudinal direction 2 also has such a concave curvature. Thus, the opening 5 forms an elastic space with the constant thickness 10 in the longitudinal direction 2 across its entire length. Because the opening 5 is furthermore constructed continuously in the transverse direction 11 perpendicular to the longitudinal direction 2, the spring element 4 constructed with a leaf-spring-like shape can yield elastically into the opening 5 under the effect of a chain force in the vertical direction 8. Thus, in a simple way, an elastic support of the timing chain 7 is guaranteed.

The chain-guiding element 1 has an attachment borehole 12 on each of its two ends viewed in the longitudinal direction 2. It is mounted on the engine block of the vehicle engine by two not-shown holding bolts passing through the two attachment boreholes 12. The spring-elastic properties of the chain-guiding element 1 are specified by the selection of the material of the chain-guiding element 1 as well as by the thickness 9 of the leaf-spring-like spring element 4 and the thickness 10 of the opening 5.

According to FIG. 2, the second embodiment of the chain-guiding element 1 differs from the first embodiment from FIG. 1 merely by a damping mass 13 inserted into the opening. The damping mass 13 is here constructed as a molded body that fills the opening 5 essentially completely. The damping mass is either held in the opening 5, in that it has dimensions that are slightly too big and presses onto the side walls of the opening, or in that its side surfaces facing the opening 5 are adhered by an adhesive to the walls of the opening 5. The damping mass 13 also supports the spring element 4 when the chain force of the timing chain 7 acts in the vertical direction 8 on the guiding surface 6 of the spring element 4. In this way, the spring-elastic properties of the spring element 4 can also be adapted to the appropriate application. In addition, the spring element is also supported during movement in the opening 5, so that the risk of mechanical damage of the spring element 4 due to a high chain force is reduced. Because the damping mass 13 has a simple geometry, its spring-elastic properties can also be easily calculated for its design.

### LIST OF REFERENCE NUMBERS

1 Chain-guiding element
2 Longitudinal direction
3 Base body
4 Spring element
5 Opening
6 Guiding surface
7 Timing chain
8 Vertical direction
9 Thickness
10 Thickness
11 Transverse direction
12 Attachment borehole
13 Damping mass

1. Chain-guiding element for a timing chain of a timing-chain drive, comprising a rigid base body, a spring element on the base body with a guiding surface for the timing chain on a side facing the timing chain and a spacing between the spring element and the base body on a side facing away from the guiding surface.

2. Chain-guiding element according to claim 1, wherein the base body and the spring element are formed as an integral component.

3. Chain-guiding element according to claim 2, wherein an opening forms the spacing between the base body and the spring element.

4. Chain-guiding element according to claim 3, wherein the guiding surface has a concave curvature.

5. Chain-guiding element according to claim 3, wherein the opening has a concave curvature.

6. Chain-guiding element according to claim 1, further comprising a damping mass at least partially filling the opening.

7. Timing-chain drive for a vehicle engine, comprising a chain-guiding element with a rigid base body, a spring element on the base body with a guiding surface for the timing chain on a side facing the timing chain and a spacing between the spring element and the base body on a side facing away from the guiding surface.

8. (canceled)
